(19) United States
(12) Patent Application Publication
(10) Pub. No.: US 2006/0229975 A1
(43) Pub. Date: Oct. 12, 2006

(54) Methods for accelerated principal reduction

(75) Inventor: Adam Wiatrak, Sausalito, CA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Duncor, LLC, Sausalito, CA (US)

(21) Appl. No.: 11/354,401

(22) Filed: Feb. 14, 2006

Related U.S. Application Data
(60) Provisional application No. 60/652,508, filed on Feb. 14, 2005.

(51) Int. Cl. G06Q 40/00

(52) U.S. Cl. 705/38

(57) ABSTRACT

A method of reducing a principal amount of a loan. The method comprises determining a payment schedule of a series of payments for repaying the principal amount of the loan, each payment comprising a principal portion and an interest portion, receiving payments, and crediting the principal portion of received payments towards the principal amount of the loan. The method also comprises investing at least a part of the principal portion in a portfolio comprising at least one investment instrument and applying at least a part of any gains made from the portfolio to the principal amount of the loan.

### CROSS-REFERENCES TO RELATED APPLICATIONS

This application is a non-provisional application and claims the benefit of Application No. 60/652,508, filed Feb. 14, 2005, entitled “Accelerated Principal Reduction Methods”, which disclosure is incorporated herein by reference for all purposes.

### BACKGROUND OF THE INVENTION

The present invention relates to methods for accelerated principal reduction, and more particularly, to methods for reducing the principal balance of a conventional loan such as a mortgage.

Borrowers enter into loan agreements with lending institutions to make a wide variety of purchases. For example, a home purchaser enters into a mortgage loan to finance the home, and an automobile purchaser enters into an automobile loan to finance the purchase of the automobile. Lending institutions enter into loan agreements to make a profit. The profit that the lender makes is derived from finance charges or interest that the borrower pays to the lender in exchange for the right to use the loaned money to make a purchase.

Thus, from the borrower's point of view, the interest paid to the lender is a loss that the borrower must incur in order to make a non-cash purchase. This interest can be a heavy burden on the borrower, especially on long-term loans, such as 20-30 year mortgages. Therefore, borrowers would benefit from an extra source of income to aid in paying the interest on the loan

### BRIEF SUMMARY OF THE INVENTION

The present invention provides a method of reducing a principal amount of a loan, where the method comprises determining a payment schedule of a series of payments for repaying the principal amount of the loan, each payment comprising a principal portion and an interest portion, receiving payments, and crediting the principal portion of received payments towards the principal amount of the loan. The method also comprises investing at least a part of at least one of the principal portion and the interest portion in a portfolio comprising at least one investment instrument and applying at least a part of any gains made from the portfolio to the principal amount of the loan.

In accordance with another aspect of the present invention, the portfolio comprises multiple investment instruments.

In accordance with a further aspect of the present invention, at least a part of the interest portion is invested in the portfolio

The following detailed description together with the accompanying Figure will provide a better understanding of the nature and advantages of the present invention.

### BRIEF DESCRIPTION OF THE DRAWINGS

FIG. 1 is a table summarizing an example of a conventional, 30 year fixed loan repayment for $350,000 in accordance with the present invention; and

FIG. 2 is a table summarizing another example of a conventional, 30 year fixed loan repayment for $350,000 in accordance with the present invention.

### DETAILED DESCRIPTION OF THE INVENTION

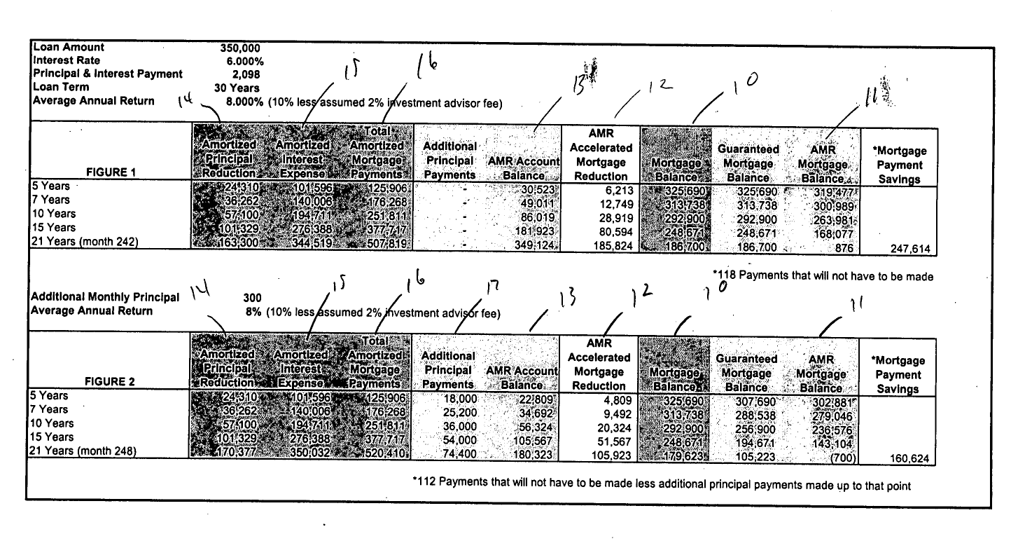

FIG. 1 illustrates an example of a $350,000 loan in a conventional (typical) manner known in the industry that reflects current market products with a 6.00% interest rate over a 30 year payment schedule, with the principal portion of the loan being invested for reducing the principal in an accelerated manner. The total monthly loan payment is $2,098. The figure illustrates the outstanding loan amount, often referred to as the principal amount, at 10 in the traditional loan system where the principal is not invested, while the accelerated mortgage reduction (“AMR”) balance is illustrated at 11.

In accordance with the present invention and continuing with the example of FIG. 1, the entire principal portion of each payment is invested in a portfolio comprising at least one investment instrument, which in the example of FIG. 1 is a fund that assumes a 10% annual return or gain on investment, less an assumed 2% for an investment advisor. This leaves an 8% annual gain, which is shown at 12. This is used to accelerate reduction of the principal amount of the outstanding loan as seen when comparing 10 and 11. As may be seen, with the example of FIG. 1, the loan is repaid in accordance with the present invention between year 20 and 21 (around month 242) as opposed to year 30 with the conventional manner. Column 13 illustrates the AMR account balance, which is the repaid principal portion of the loan and the return from investing the principal portion. Columns 14-16 summarizes typical amounts for a 30-year fixed loan at 6.00% without the accelerated principal reduction in accordance with the present invention.

Those skilled in the art will understand that a smaller part of the principal portion may be invested if desired. Furthermore, other types of loans, such as variable interest rate loans, may be used. Those skilled in the art will understand that types of loans include, for example, lines of credit, credit cards, etc. Additionally, a portion or even all of the interest part of a payment may be invested if desired. For example, the interest rate may be listed as the Prime rate plus 2% and only the interest resulting from the 2% may be invested if desired. Also, each payment does not have to contribute a portion to be invested in the portfolio. Payments may also be funded into the investment vehicle through negative amortization of the principle loan balance if desired.

Additional principal payments above the specified payment schedule of the loan may be made and may be invested if desired. Such an example is illustrated in FIG. 2 where an extra principal payment of $300 is made monthly and invested to accelerate reduction of the principal amount of the loan. In this example, none of the principal portion or the investment portion of the $2,098 monthly payment is invested. However, a portion may be invested if desired. Column 17 illustrates the additional principal payments. Column 13 includes the total of the returns on the investing of the additional principal payments from column 12 and the additional principal payments themselves from column 17.

Preferably, the lender will leverage their risk by the use of put or call option strategies that may further enhance the returns and offset the principal balance at a quicker rate than noted in the above example of FIG. 1. More importantly, the use of option contracts insures that declining markets will not have a negative effect on the investment account for the lender or the borrower.

Accordingly, the present invention provides a better method to reduce and/or eliminate the principal balance with respect to conventional loan strategies. The method provides for at least part of the conventional payments by the borrower to be invested in the stock, bond, futures or options markets by the lender, with at least part, and preferably all, of the investment gains offsetting the borrowers' principal balance. The result, compared to current conventional loans, with no risk or extra payments by the borrower, is that the principal balance may (depending on market conditions) be eliminated at a quicker and more efficient rate.

This is accomplished by the lender investing the principal part of the regular payments made by the borrower, into a portfolio comprising at least one investment instrument in the stock, bond, futures or options markets; then, crediting back the principal paid by the borrower plus all gains made by the investment back to the borrower's current principal balance. Market risk for the investments is covered by put and call option strategies known in the industry.

Although the invention has been described with respect to exemplary embodiments, it will be appreciated that the invention is intended to cover all modifications and equivalents within the scope of the following claims.

What is claimed is:

1. A method of reducing a principal amount of a loan, the method comprising:
determining a payment schedule of a series of payments for repaying the principal amount of the loan, each payment comprising a principal portion and an interest portion;
crediting the principal portion of any payments made towards the principal amount of the loan;
investing at least a part of at least one of the principal portion and the interest portion in a portfolio comprising at least one investment instrument; and
applying at least a part of any gains made from the portfolio to the principal amount of the loan.

2. A method in accordance with claim 1 wherein the portfolio comprises multiple investment instruments.

3. A method in accordance with claim 1 wherein at least a part of the interest portion of is invested in the portfolio.

4. A method in accordance with claim 1 wherein at least a part of the principal portion is invested in the portfolio.

5. A method in accordance with claim 1 wherein an additional payment for reduction of the principal amount is received with a payment and is invested in the portfolio.

6. A method of reducing a principal amount of a loan, the method comprising:
determining a payment schedule of a series of payments for repaying the principal amount of the loan, each payment comprising a principal portion and an interest portion;
crediting the principal portion of any payments made towards the principal amount of the loan;
receiving an additional payment for reduction of the principal amount with a payment;
investing at least a part of at least one of the additional payment, the principal portion and the interest portion in a portfolio comprising at least one investment instrument; and
applying at least a part of any gains made from the portfolio to the principal amount of the loan.
